(19) United States
(12) Patent Application Publication
(10) Pub. No.: US 2005/0186974 A1
(43) Pub. Date: Aug. 25, 2005

(54) Short message service (SMS), multimedia message service (MMS), call screening and filtering

(76) Inventor: Yigang Cai, Naperville, IL (US)

Correspondence Address: WERNER ULRICH, 434 MAPLE STREET, GLEN ELLYN, IL, 60137-3826, US

(21) Appl. No.: 10/772,658

(22) Filed: Feb. 5, 2004

(51) Int. Cl. H04Q 7/20

(52) U.S. Cl. 455/466

(57) ABSTRACT

A method and apparatus for screening short message service (SMS) and/or multimedia message service (MMS) calls. An originator of an SMS/MMS call is checked for authorization to send the type of message (e.g., to roamers, to non-local destinations, broadcast messages). If the caller is found to be authorized then the called party or parties are checked to determine whether they are screening calls of the type and from the source of the caller. In either case, if the telecommunications network determines that the call should be blocked the caller is notified and the call is not completed. Advantageously, this arrangement sharply reduces the amount of SPAM delivered by SMS/MMS service.

### TECHNICAL FIELD

This invention relates to call screening and filtering, to protect against a flood of SPAM messages, in short message service and multimedia message service.

### BACKGROUND OF THE INVENTION

The prevalence of e-mail service has made it possible to send e-mail to many recipients with very little effort on the part of the sender. The result has been a great increase in the amount of unwanted e-mail messages (frequently called SPAM). There have even been laws to make this process more difficult.

While various filtering arrangements have been made available for e-mail, only the most primitive arrangements for filtering are available for short message service (SMS) and multimedia message service (MMS). Since the basic objective of SMS and MMS is to communicate immediately it is especially important to ensure that the recipient receives as little SPAM as possible since in contrast to e-mail the recipient cannot conveniently arrange to go through a long list of received messages at his/her convenience. In today's wireless networks, an SMS Center (SMSC) will allow a subscriber to define certain number of Mobile Directory Numbers (MDNs) or Mobile Identification Numbers (MINs) and email addresses in a black list for mobile originated SMS screening so that any SMS originated by the mobile phone number or email from this list will be blocked. However, those simple SMS screening/filtering methodologies (the screening/filtering only blocks mobile originating phone numbers and emails) do not efficiently prevent other forms of mobile telephony screening and other various types of spamming.

The lack of more powerful filtering services with SMS or MMS (SMS/MMS) is bound to have a sharp negative impact on the use of SMS/MMS and on the number of subscribers who will purchase such services.

### SUMMARY OF THE INVENTION

The above problem is solved and an advance is made over the prior art in accordance with this invention wherein a short message service center or multimedia message service center performs screening based on information provided by a service provider (carrier) for an SMS/MMS terminal for both originating and terminating screening of SMS/MMS calls. The screening based on origination and destination geographical area and roaming characteristic is part of the class of service of the caller and is provided by the service provider. Receiver names, alias, and e-mail addresses are provided by the sender and are originating screening options. The sender IP addresses, domains, key words, subject title, URL of web pages, SMS/MMS messages service types (e.g., messages advertisement broadcast stock information/trading), content type, language restrictions are provided by the called party and are used for originating and terminating screening. Advantageously, these arrangements provide a caller with facilities to manage his/her load and charges and provide called parties with the highly flexible means for filtering unwanted SMS/MMS messages.

### BRIEF DESCRIPTION OF THE DRAWING(S)

FIG. 1 is a block diagram illustrating the operation of short message service;

FIG. 2 is a flow diagram illustrating originating screening for short message service/multimedia message service (SMSC/MMSC); and

FIG. 3 is a flow diagram illustrating the operation of screening incoming SMS/MMS messages.

### DETAILED DESCRIPTION

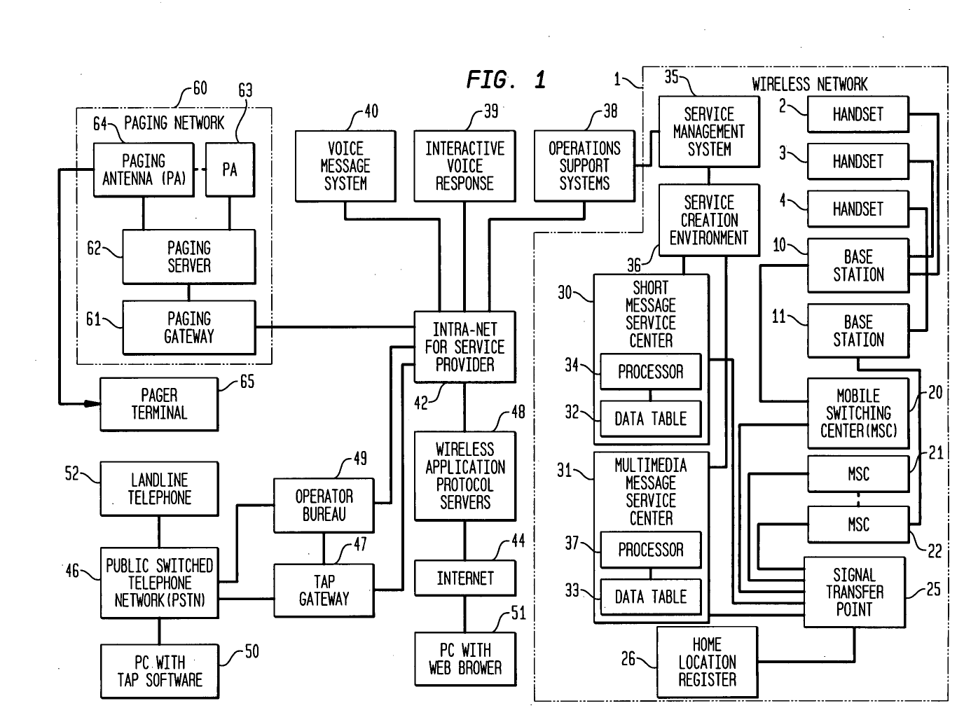

FIG. 1 is a block diagram showing the operation of short message service and multimedia message service. A large network blocks include the wireless network 1, the Internet 44, the service provider's LAN/WAN (Local Area Network/Wide Area Network) network 42 which is within a firewall from the open Internet 44, based on transmission control protocol/Internet protocol (TCP/IP), a paging network 60, and the public switched telephone network 46. The recipients of short message service (SMS) and multimedia message service (MMS) are the wireless stations 2, 3, 4. In accordance with this invention, all short message service messages and multimedia service messages are switched through one of the short message service center/multimedia message service center (SMSC/MMSC) units 30, 31. Signaling messages are routed through a signal transfer point (STP) 25 to a home location register (HLR) 26 and to one of a plurality of mobile switching centers 20, 21, 22. The mobile switching centers are connected to base stations 10 and 11 which communicate with the mobile stations 2, 3, and 4.

Control information for the SMSC/MMSC 30, 31 is provided from a service creation environment 36 which receives information from a service management system 35. (The service management system is defined by Telcordia as an intelligent network element.) SMS 35 in turn receives information from an operation support system (OSS) 38.

The service provider's intra-network 42 is serviced by a voice message system 40 and an interactive voice response system 39 for cases in which voice message service or interactive voice response service is required. For example, the interactive voice response system may be used to communicate with a customer in order to derive data for that customer's message filtering needs in the SMSC/MMSC. The voice mail system sends notice messages to SMSC/MMSC if subscriber's voice mail exceeds a threshold or there is an urgent voice mail waiting to be retrieved.

The service provider's network communicates via a web gateway/wireless application protocol (WAP) gateway and information and WAP servers 48 with the Internet 44 which communicates with stations such as station 51 equipped with a web browser. Subscribers use the browser from the computer desktop to provision screening/filtering provisioning on SMSC/MMSC. The public switched telephone network (PSTN) 46 communicates via a telocator alphanumeric protocol (TAP) gateway 47 with the service provider's network 42 and thence can communicate with the SMSC/MMSC 30, 31. The PSTN serves landline telephone 52 and station 50 having a PC and having client software using TAP. An operator bureau 49 also communicates with the service provider's network 42. The operator bureau acts as an administrator to SMSC/MMSC. It also sends broadcasting SMS/MMS to broad audiences via the SMSC/MMSC.

Finally, a paging network 60 communicates using the telocator network paging protocol (TNPP) with the service provider's network 42. The paging network sends numerical paging info to SMSC/MMSC which forwards numerical paging as an SMS/MMS to subscriber's handset. The paging network communicates via paging gateway 61 which controls a plurality of paging servers 62, each of which controls a plurality of paging stations 63, 64. The paging stations communicate with a paging terminal 65.

Screening of SMS/MMS messages is implemented in the SMSC/MMSC 30, 31 and specifically in data tables 32, 33 stored in these units. The data tables are accessed by control processors 34, 37 of these units. These data tables are consulted in order to filter out unwanted SMS and MMS messages and to let acceptable SMS and MMS messages be passed to their recipients. The SMSC/MMSC can also access data tables of other units such as the HLR 26 to obtain information for screening such messages.

The short messages can be displayed on appropriately equipped wireless handsets 1, 2, 3 and on the PC equipped stations 50, 51. They can also be displayed at operator stations in the operator bureau 49 and on paging terminals 65. They can be displayed on landline telephones 52 that are equipped with, for example, caller ID displays. An SMS can be transmitted to a station as a voice message and/or which can be originated by the station as a voice message from or to an appropriately equipped VMS.

The SMSC/MMSC currently provides or is expected to provide the following services:
1. Delivery of a notification of voice mail or a fax message to telecommunications stations, either the handset or a display.
2. Delivery of text messages sent to a wireless station via the Internet.
3. Transmitting e-mail messages to a subscriber's unit via text-to-speech equipment, short text message page or via an interactive text message session. The Internet web provides the SMS/MMS capability.
4. Paging with callback extraction; the paging network transmits very low bandwidth information numerical paging between handset and paging terminal.
5. Users can send messages from their desktop environment to SMS/MMS subscribers.
6. Users can interface with an operator or other message bureau or an interactive voice response (IVR) unit to allow users to send SMS/MMS messages through an operator bureau; can be used for broadcasting messages or through IVR to send a voice message, translated by an IVR into an SMS message.
7. Broadcast lists can support delivery of a single message to multiple users of the list. For example, specific types of information (e.g., stock prices) can be delivered to one or more stations at prescribed times.
8. Automatic mobile paging escalation to wider areas for text messages that cannot be delivered when the mobile unit is outside the service area.
9. Interaction with information servers to allow end users to receive information.
10. Delivery of image photo and audio visual audio video streaming to a mobile station (e.g., stock, weather, sport event information) via an MMSC.

The anti-spamming screening criteria implemented in the SMSC/MMSC will now be discussed. The following is a list of general screening/filtering criteria:
1. Origination and destination, geographical area screening for mobile directory numbers so that acceptance or delivery of calls outside predefined geographic areas can be restricted. Geographical areas can be grouped or categorized as local area, local area code area, national area, international (country code) area, and special service number.
2. Sender and receiver main alias and e-mail addresses for either positive screening, i.e., only allowing certain sources, or exclusionary or negative screening excluding certain sources.
3. Sender and receiver IP addresses/full names.
4. Key words, subject title, uniform resource location (URL) of web page included in the SMS/MMS messages.
5. Service types (messages, advertisement broadcasts, stock information/trading, online purchasing, dating, games, train/bus schedules, news, weather, banking). Service types are from a list refined by a service provider and are specified as a parameter in the header of a message.
6. Content classifications (e-mail, image, audio, video). For example a subscriber might be allowed to receive SMS but not MMS.
7. Merchant names or identification.
8. Language restrictions. There is a language label in the header.
9. Threshold for SMS/MMS mass distribution. (For example, a subscriber may state a threshold of 10 in which case no message aimed to be distributed to more than 10 receivers will be filtered for this subscriber.)

Another category of screening is by the type of service of the originating mobile.
1. Permission to send SMS/MMS messages to another mobile station.
2. Permission to send e-mail messages from the mobile unit.
3. Direct e-mail to another mobile station. The e-mail is sent via the IP network to the SMSC/MMSC of the destination mobile station. Screening can then be applied by the latter unit to ensure that the called mobile station is willing to accept this type of message.
4. Digital paging messages for delivery to a pager via the paging network.
5. Delivery to user groups (mass delivery). The user group can be predefined in subscriber personal data in the SMSC/MMSC database or the originating subscriber can compose a user group for the particular message.
6. Broadcast messages.
7. Interaction with wireless application protocol (WAP) or other client servers to check for the ability to send requests for information, stock trading, or online purchases.

Screening can also be performed for the mobile terminating unit:
1. Voice mail and fax mail notification. If a voice call or a fax call is deflected to voice message service on busy or no answer indications, the VMS notifies the SMSC/MMSC with the mobile terminating number. The SMSC/MMSC receives the message and applies screening criteria. Basically, if a direct call would not have been completed then the recorded call is also not completed. However, if screening is passed, the SMSC/MMSC sends the voice mail/fax message to the mobile switching center serving the receiving mobile station to forward the message to that station.
2. Mobile terminating inbound SMS/MMS messages. The terminating station performs screening on incoming messages to determine whether it wishes to receive such messages. For example, if the message is a mass distribution message with 100 destinations and the terminating station rejects all mass distribution messages with more than 50 destinations, the message will not be transmitted.
3. Inbound paging. An originating subscriber composes an SMS message for delivery to a pager in the paging network. The SMSC/MMSC receives the message and applies screening criteria for the paging unit. If the screening is passed, the SMSC/MMSC sends the message via the TCP/IP network to the paging gateway which forwards it to the receiving pager.
4. Inbound web-based messaging. An originating subscriber connects to a web server and composes an SMS/MMS message and submits this message to the gateway server which forwards it to the SMSC/MMSC for delivery to the terminating mobile station. The SMSC receives the message and applies the normal screening criteria prior to forwarding the message to the MSC serving the terminating mobile station.
5. Specifically identified mobile terminal (MT inbound e-mail message.
6. MT inbound message via operator bureau or interactive voice response (IVR). An originating subscriber calls the operator for the IVR equipment and provides the message content and delivery address. The operator/IVR accepts the message and forwards it to the SMSC/MMSC. The SMSC/MMSC receives the message and applies screening criteria. If the screening is passed, the SMSC/MMSC sends the message to the MSC serving the terminating mobile station.
7. Inbound message from information services. An information server delivers data packets to the SMSC/MMSC. The SMSC/MMSC receives the message and applies screening criteria. If the screening is passed, the SMSC/MMSC sends the message to the MSC serving the terminating mobile station.
8. Message for mass delivery screens the sender prior to delivery to the destination.
9. Broadcast message screens the sender prior to delivery of the broadcast message.

If an SMS/MMS message is screened, the SMSC/MMSC will send an appropriate notification to the message sender indicating the reason for screening the message. For multiple destination or mass distribution messages, the explanation notification may indicate which destinations are barred for which reason. A Call Detail Record/Event Detail Record is generated for barred messages or an information message can be sent to an announcement center or help desk.

Either the service provider or the subscribers can define and activate/deactivate a screening criteria list. The screening criteria list is subject to modifications. The modifications include deleting, modifying and adding entries, and turning the screening off and on.

Service providers can define a general screening criterion which may apply to all or a subset of the subscribers. An example would be a geographic zone. Service providers can create, search, view, and modify the screening criteria list at a computer attached to an operations support system 38. Subscribers can define screening criteria through:
1. At the point of sale of the handset for entry via an operations support system 38;
2. Via a call to the operator who can access the database via the operations support system;
3. Via the service provider's web site which can access the operations support system through the Internet. Subscribers can search, view, and modify the screening list through a call to the operator; using dual tone multifrequency (DTMF) or unstructured supplementary service data (USSD) capability of the handset.
4. Through a connection to the service provider's web site. A graphical user interface (GUI) can be used for interacting with the web site.

An updated list is then stored in the SMSC/MMSC database or, if there are many SMSC/MMSCs, through a centralized network database (not shown).

When a wireless subscriber receives any unwanted SMS/MMS message, the subscriber can forward the SMS/MMS message to a network address that will automatically add the sender's identity to the list of sources which will be blocked in the future. This capability can be activated or deactivated by the subscribers. Similarly, subscribers can automatically add the SMS/MMS sender of a message to an accept list so that any subsequent messages from this sender will be passed. One of more languages will be applied to the SMS/MMS screening when the language label is turned on the screening/filtering functionality.

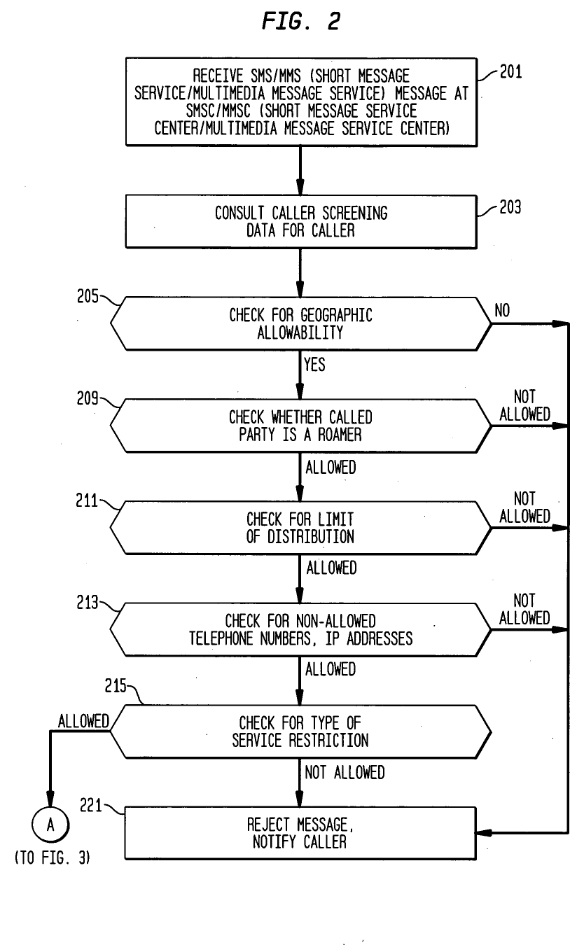

FIG. 2 illustrates the process of screening short message service (SMS) messages or multimedia message service (MMS) messages prior to transmitting them to one or more recipients. An SMS/MMS message is received at a short message service center/multimedia message service center (SMSC/MMSC) (action block 201). A database for the caller is consulted to determine whether this type of message can be transmitted in terms of the allowable services of the originator (action block 203). The database is integrated in SMSC/MMSC, or, especially for SMS/MMS messages originated by land-line stations, e.g., via a web site of the Internet, from a database associated with the caller. The data of the caller is checked for geographic allowability of the called parties, i.e., whether the called party is within a geographic district defined by the class of service of the caller (action block 205). The geographic district can usually be identified by the called telephone number. IP addresses can also be allowed or denied by the class of service of the caller.

Test 209 determines whether calls may be sent to a roamer and, if not, checks whether any of the called parties are roamers. Test 211 checks for the limit of distribution, i.e., the number of addressees. Test 213 checks whether any of the addressees are not allowed telephone numbers or IP addresses; calls to such numbers or IP addresses are blocked. Test 215 checks for the type of service restriction, e.g., whether the calls can go to Internet terminals or can only go to wireless terminals. If any of these tests fail then the call is not completed to the parties for which the test fails and a reject message is sent to the caller (action block 22 1).

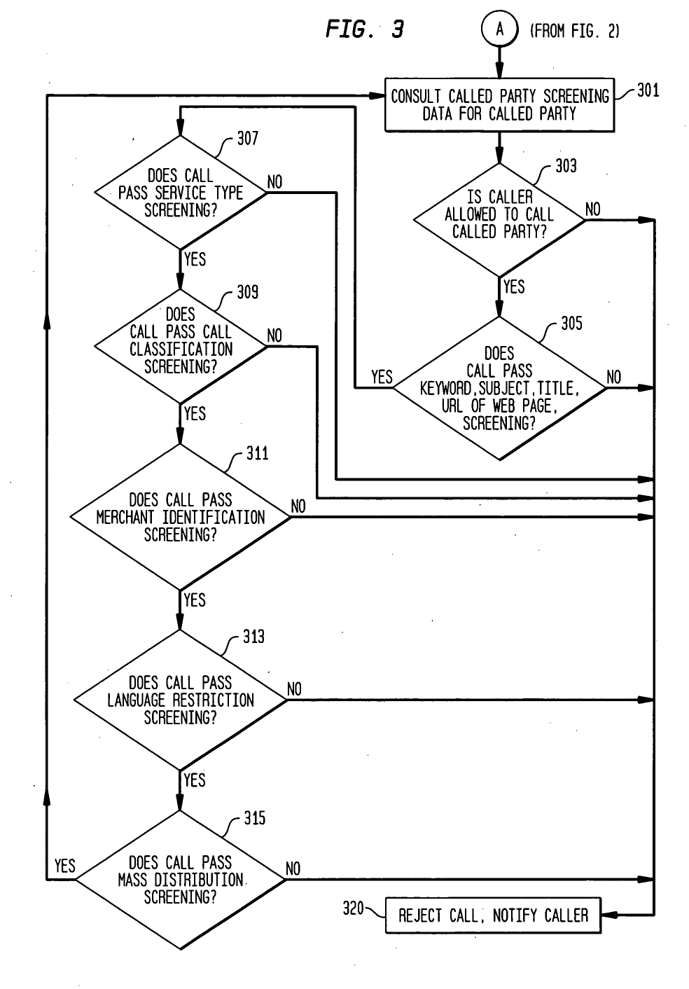

Before the call is completed, called party screening is performed (FIG. 3). The SMSC/MMSC screening system consults the appropriate database for called party screening data for the called party (action block 301). Test 303 determines whether the caller is allowed to call the called party or whether the caller is effectively on a blacklist of the called party. Test 305 checks whether the keyword, subject, title, or URL of the web page, of messages to the called party is screened and if so whether the calling party's identification and text passes this screening. Test 307 determines whether the call passes a call type screening. Test 309 determines whether the call passes call classification screening. Test 311 determines whether the call passes merchant identification screening to screen out merchants known to send SPAM. Test 313 tests whether the call passes language restrictions screening to make sure that only calls with text in the appropriate language(s) are passed. Test 315 determines whether the call passes mass distribution screening, i.e., whether the number of recipients is below a threshold specified by the called party. If any of these tests fail, the call is rejected and the caller is notified (action block 320).

The above description is of one preferred embodiment of Applicant's invention. Other embodiments will be apparent to those of ordinary skill in the art without departing from the scope of the invention. The invention is limited only by the attached claims.

1. A method of screening a Short Message Service (SMS) or Multimedia Message Service (MMS) call in an SMS or MMS center, comprising the steps of:
responsive to receipt of an SMS or MMS call, determining whether a calling party of said call may attempt to complete said call;
responsive to determining that a caller of said call may attempt to complete said call, determining whether a called party of said call is willing to accept calls from said calling party; and
determining whether said called party has allowed calls having characteristics of said call to be completed to said called party;
wherein the step of determining whether said called party is willing to accept calls from said calling party comprises the step of determining whether said called party has screened calls from said calling party.

2. The method of claim 1 wherein the step of determining whether said calling party may attempt to complete said call comprises the steps of:
determining the number of destinations which said calling party is attempting to reach; and
rejecting said call if said number exceeds a limit defined by a class of service of said calling party.

3. The method of claim 1 wherein the step of determining whether said called party is willing to accept calls from said calling party comprises the steps of:
determining the number of destinations which said calling party is attempting to reach; and
rejecting said call if said number exceeds a limit defined by a class of service of said called party.

4. The method of claim 1 wherein the step of determining whether said calling party of said call may attempt to complete said call comprises the step of testing for geographic allowability of a call to said called party in accordance with a class of service of said calling party.

5. The method of claim 1 wherein the step of determining whether said calling party may attempt to complete said call comprises the steps of:
testing whether said calling party may complete SMS or MMS calls to a roamer; and
if said calling party may not complete SMS or MMS calls to a roamer, determining whether said called party is a roamer and blocking said call if said called party is a roamer.

6. The method of claim 1 wherein the step of determining whether a calling party of said call may attempt to complete said call comprises the step of testing whether a destination number of said called party is in a list of numbers to which said calling party may not complete SMS or MMS calls.

7. The method of claim 1 wherein the step of determining whether said calling party may attempt to complete said call comprises the step of testing whether said calling party may originate a service type of said call.

8. The method of claim 1 wherein the step of determining whether said called party is willing to accept calls comprises the step of testing whether the keyword, subject, title, or URL of a web page of said SMS or MMS call is on a list of call types which said called party does not wish to receive.

9. The method of claim 1 wherein the step of determining whether said called party is willing to accept calls from said calling party comprises the step of testing whether the service type of said call is one which said called party is willing to accept.

10. The method of claim 1 wherein the step of determining whether said called party is willing to accept calls from said calling party comprises the step of testing whether a content classification of said call is one which said called party is willing to accept.

11. The method of claim 1 wherein the step of determining whether said called party is willing to accept calls from said calling party comprises the step of determining whether said call identifies a merchant from which said called party does not wish to receive SMS or MMS calls.

12. The method of claim 1 wherein the step of determining whether said called party is willing to accept calls from said calling party comprises the step of testing whether a language of said call is one which said called party is willing to accept.

13. In a Short Message Service (SMS) or Multimedia Message Service (MMS) center, apparatus for screening an SMS or MMS call, comprising:
means, responsive to receipt of an SMS or MMS call, for determining whether a calling party of said call may attempt to complete said call; and
means, responsive to determining that said calling party may attempt to complete said call, for determining whether a called party of said call is willing to accept calls from said calling party, comprising means for determining whether said called party has allowed calls having characteristics of said call to be completed to said called party;
said means for determining whether said called party is willing to accept calls from said calling party comprises means for determining whether said called party has screened calls from said calling party.

14. The apparatus of claim 13 wherein the means for determining whether said calling party may attempt to complete said call comprises:
means for determining the number of destinations which said calling party is attempting to reach; and
means for rejecting said call if said number exceeds a limit defined by a class of service of said calling party.

15. The apparatus of claim 13 wherein the means for determining whether said called party is willing to accept calls from said calling party comprises:
means for determining the number of destinations which said calling party is attempting to reach; and
means for rejecting said call if said number exceeds a limit defined by a class of service of said called party.

16. The apparatus of claim 13 wherein the means for determining whether said calling party may attempt to complete said call comprises means for testing for geographic allowability of a call to said called party in accordance with a class of service of said calling party.

17. The apparatus of claim 13 wherein the means for determining whether said calling party may attempt to complete said call comprises:
means for testing whether said calling party may complete SMS or MMS calls to a roamer; and
means, responsive to determining that said calling party may not complete SMS or MMS calls to a roamer, for determining whether said called party is a roamer and blocking said call if said called party is a roamer.

18. The apparatus of claim 13 wherein the means for determining whether said called party is willing to accept calls comprises means for testing whether the keyword, subject, title, or URL of a web page of said SMS or MMS call is on a list of call types which said called party does not wish to receive.

19. The apparatus of claim 13 wherein the means for determining whether said called party is willing to accept calls from said calling party comprises means for determining whether said call identifies a merchant from which said called party does not wish to receive SMS or MMS calls.

20. The apparatus of claim 13 wherein the means for determining whether said called party is willing to accept calls from said calling party comprises means for testing whether a language of said call is one which said called party is willing to receive.
